(19) United States
(12) Patent Application Publication
(10) Pub. No.: US 2005/0180534 A1
(43) Pub. Date: Aug. 18, 2005

(54) Iterative estimation and equalization of asymmetries between inphase and quadrature branches in multicarrier transmission systems

(75) Inventors: Lars Brotje, Wachtberg (DE); Sven Vogeler, Bremen (DE); Volker Kuhn, Bremen (DE); Karl Dirk Kammeyer, Buchholz (DE)

Correspondence Address: Andreas Grubert, Baker Botts L.L.P., 910 Louisiana, One Shell Plaza, Houston, TX, 77002-4995, US

(73) Assignee: Infineon Technologies AG

(21) Appl. No.: 11/075,310

(22) Filed: Mar. 8, 2005

Related U.S. Application Data
(63) Continuation of application No. PCT/DE03/02849, filed on Aug. 26, 2003.

(30) Foreign Application Priority Data
Sep. 9, 2002 (DE) 102 41 679.6

(51) Int. Cl. H04B 17/00

(52) U.S. Cl. 375/350

(57) ABSTRACT

Distortions of radio signals transmitted in data blocks in an OFDM method, the distortions being caused by transmitter- or receiver-end IQ asymmetries and by channel distortion, can be estimated and equalized by means of an iteration method. The method can be used particularly advantageously in a direct-mixing receiver.

### CROSS REFERENCE TO RELATED APPLICATION

This application is a continuation of copending International Application No. PCT/DE03/02849 filed Aug. 26, 2003 which designates the United States, and claims priority to German application No. 102 41 679.6 filed Sep. 9, 2002.

### TECHNICAL FIELD OF THE INVENTION

The present invention relates to a method for the estimation and correction of the distortion of radio signals which is caused by transmitter- or receiver-end IQ asymmetries and by channel distortion, which radio signals are transmitted in a multicarrier transmission method, and to a device for carrying out the method.

### BACKGROUND OF THE INVENTION

Within the European DVB (Digital Video Broadcasting) system, digital transmission systems for satellite (DVB-S), for cable (DVB-C) and for terrestrial digital broadcasting transmission (DVB-T) have been developed and corresponding specifications have been elaborated therefor. On account of the problematic transmission conditions present on the terrestrial radio channel, the transmission method that has been prescribed in the DVB-T specification is the OFDM transmission method (orthogonal frequency division multiplexing), which can effectively combat the difficult transmission conditions.

A further important area of application for the OFDM transmission method is in high-rate wireless data transmission networks such as, for example, WLAN (Wireless Local Area Network), in particular the transmission methods defined in the standards IEEE802.11a and 11g and also HIPERLAN/2.

The OFDM transmission method is a multicarrier transmission method in which the data stream is divided between a number of parallel (orthogonal) subcarriers that are in each case modulated with a correspondingly low data rate. As is illustrated in FIG. 1, (sub)carrier frequencies are arranged such that they are spaced apart equidistantly from one another on the frequency scale within a transmission bandwidth K. The carrier frequencies lie on both sides of and symmetrically with respect to a center frequency f_{c}. In the time domain, an OFDM symbol results from the superposition of all K carrier frequencies. The data transmission is effected in the form of frames or bursts, a frame containing a uniform number of OFDM symbols.

The reception and the demodulation of OFDM radio signals may be effected by conventional reception concepts based on the principle of heterodyne reception with subsequent digital quadrature mixing. However, primarily for reasons of lower power consumption and avoiding chip-external filters for image frequency suppression, preference is increasingly being given to more advanced reception concepts employing direct-mixing methods. In the case of direct-mixing receiver concepts, the radio signal that is received via an antenna and amplified is split into an inphase (I) and a quadrature (Q) branch and mixed with the output frequency of a local oscillator in both branches, the oscillator frequencies fed to the mixers being shifted reciprocally by 90° by means of a phase shifter. Consequently, the quadrature demodulation for recovering the information-carrying baseband signals is implemented using analog circuit technology in this reception concept.

Technology-dictated inaccuracies in the production process and non-idealities of the analog mixers and oscillators and also deviations between the filters in the I and Q branches give rise to so-called IQ asymmetries or IQ distortions, i.e. amplitude and phase asymmetries between the quadrature components. The real and imaginary parts of the complex baseband signal are not phase-shifted by exactly 90° relative to one another and amplitude deviations between I branch and Q branch further occur. Such IQ asymmetries may occur both in the transmitter and in the receiver. In the receiver, the IQ asymmetries in the case of OFDM-based transmission systems, in the frequency domain, that is to say after the FFT transformation (Fast Fourier Transform) in the receiver, leads to a reciprocal interference between in each case two data symbols on the subcarriers whose frequencies are arranged symmetrically with respect to the center frequency f_{c} of the OFDM spectrum (indicated hereinafter by the subcarrier indices n and −n). Each data symbol transmitted on the subcarrier n generates a signal contribution on the subcarrier with the index −n (image frequency) as a result of the IQ asymmetry added in the time domain. The superposition leads to distortions of the useful signals at the positions n and −n.

In the dissertation “Verfahren der digitalen Kompensation von Unsymmetrien der analogen Quadraturmischung in OFDM-Empfängern [Method for the digital compensation of asymmetries of the analog quadrature mixing in OFDM receivers]” by Andreas Schuchert, accepted by the faculty of electrical engineering and information technology at the Bergischen Universität-Gesamthochschule Wuppertal, chapter 4 gave a mathematical description of the IQ asymmetries and supplied a quantitative estimation of the interference contribution occurring at the image frequency of a desired signal. Chapter 6 of the aforementioned dissertation proposes two different methods for IQ error compensation by frequency domain equalization. The first method proposed therein enables a separate frequency-dependent compensation of IQ asymmetries. For the detection of the equalization parameters by means of an IQ error detector, it is also proposed to utilize the pilot carriers that are transmitted for the purpose of estimating the channel transfer function as training symbols for the purpose of estimating the IQ distortions. However, the circuit arrangements—provided for error compensation—of both methods presented have a relatively large number of function blocks and are thus characterized by a high implementation outlay.

WO 02/056523 discloses a further method by means of which transmitter- and receiver-end IQ asymmetries can be eliminated. This method is based on generating compensation signals corresponding to the IQ errors and using them for the compensation.

### SUMMARY OF THE INVENTION

Consequently, it is an object of the present invention to specify methods for the estimation and subsequent equalization of the distortion of radio signals which is caused by transmitter- or receiver-end IQ asymmetries in multicarrier transmission systems, in particular OFDM transmission systems, and corresponding devices for carrying them out which can be implemented with a lower outlay.

This object can be achieved by a method for the estimation and correction of the distortion of radio signals that is caused by transmitter-end IQ asymmetries and by channel distortion, given known receiver-end IQ asymmetry, comprising the step of transmitting radio signals in a multicarrier transmission method with subcarriers n and subcarriers −n arranged spectrally symmetrically with respect to the latter with regard to a center frequency f_{c}, wherein

a) the received data symbols of a first data block are firstly equalized with the channel coefficients determined from the preceding data block,

b) the data symbols are subsequently equalized with the IQ distortion parameters determined from a temporally preceding data block,

c) the equalized data symbols are subsequently subjected to a symbol decision process, and

d) reference symbols supplied from the symbol decision process and the received data symbols are provided for a channel estimation for generating new channel coefficients, and

e) assuming that

$$[ \begin{matrix}{\hat{d}}_{n}^{′} ( i ) \\ {\hat{d}}_{- n}^{′ *} ( i )\end{matrix} ] = \underbrace{[ \begin{matrix}{C}_{n} & 0 \\ 0 & {C}_{- n}^{*}\end{matrix} ]}_{C} \cdot \underbrace{[ \begin{matrix}{a}_{n}^{TX} & {b}_{n}^{TX} \\ {b}_{- n}^{TX *} & {a}_{- n}^{TX *}\end{matrix} ]}_{{A}^{TX}} \cdot [ \begin{matrix}{d}_{n} ( i ) \\ {d}_{- n}^{*} ( i )\end{matrix} ]$$

where \hat{d}′ₙ(i) are the distorted symbols received on the subcarrier n at the instant i, dₙ(i) are the undistorted transmitted symbols, A^{TX} forms the transmitter-end IQ distortion matrix,

and C contains the channel coefficients of the multipath channel,

and furthermore assuming that aₙ^{TX}, a₋ₙ^{TX}≈1, the new distortion parameters \hat{b}ₙ^{TX}, \hat{b}ₙ^{TX} are generated in accordance with

$${\hat{b}}_{n}^{TX} = \frac{{\hat{d}}_{n}^{′} ( i ) - {C}_{n} \cdot {d}_{n} ( i )}{{C}_{n} \cdot {d}_{- n}^{*} ( i )}$$

$${\hat{b}}_{- n}^{TX} = \frac{{\hat{d}}_{- n}^{′} ( i ) - {C}_{- n} \cdot {d}_{- n} ( i )}{{C}_{- n} \cdot {d}_{n}^{*} ( i )}$$

At the beginning of the method, the data symbols contained in an initialization data block are equalized in method steps a) and b) in such a way that a channel estimation is carried out on the basis of pilot signals, and the received data symbols are equalized in method step a) with the channel coefficients determined from the channel estimation, and the IQ distortion parameters are set to be equal to zero in method step b). The method may further include the step of: f) with the new channel coefficients and new IQ distortion parameters determined in method steps d) and e), method steps a) to e) are repeated for the received data symbols of a second data block that temporally succeeds the first data block, and g) the received data symbols of the first data block are equalized with the new channel coefficients and new IQ distortion parameters determined in method step f). Alternatively the method may further include the step of: f) with the new channel coefficients and new IQ distortion parameters determined in method steps d) and e), methods steps a) to e) are repeated for the received data symbols of the first data block, and g) the received data symbols of the first data block are equalized with the new channel coefficients and new IQ distortion parameters determined in method step f). In method step d), the new channel coefficients can be generated by virtue of the fact that the channel coefficients determined from a channel estimation on the basis of the reference symbols supplied by the symbol decision process and the received data symbols are subjected to a weighted averaging with the old values of the channel coefficients. In method step e), the new IQ distortion parameters can be generated by virtue of the fact that the IQ distortion parameters determined on the basis of the new channel coefficients determined during the channel estimation, the reference symbols and the received data symbols are averaged with the IQ distortion parameters determined in one or more previous iteration steps. Prior to method step d), an IQ predistortion of the reference symbols supplied by the symbol decision process can be carried out on the basis of the updated IQ distortion parameters.

The object can also be achieved by a method for the estimation and correction of the distortion of radio signals that is caused by receiver-end IQ asymmetries and by channel distortion, given known transmitter-end IQ asymmetry, comprising the step of: transmitting radio signals in a multicarrier transmission method with subcarriers n and subcarriers −n arranged spectrally symmetrically with respect to the latter with regard to a center frequency f_{c}, wherein

a) the received data symbols of a first data block are equalized with the IQ distortion parameters determined from a temporally preceding data block,

b) the IQ-equalized data symbols are subsequently fed to a channel estimation for determining channel coefficients,

c) the data symbols are subsequently equalized with the channel coefficients, and

d) the channel-equalized data symbols are subjected to a symbol decision process, and

e) assuming that

$$[ \begin{matrix}{\hat{d}}_{n}^{′} ( i ) \\ {\hat{d}}_{- n}^{′ *} ( i )\end{matrix} ] = \underbrace{[ \begin{matrix}{a}_{n}^{RX} & {b}_{n}^{RX} \\ {b}_{- n}^{RX *} & {a}_{- n}^{RX *}\end{matrix} ]}_{{A}^{RX}} \cdot \underbrace{[ \begin{matrix}{C}_{n} & 0 \\ 0 & {C}_{- n}^{*}\end{matrix} ]}_{C} \cdot [ \begin{matrix}{d}_{n} ( i ) \\ {d}_{- n}^{*} ( i )\end{matrix} ] ,$$

where \hat{d}′ₙ(i) are the distorted symbols received on the subcarrier n at the instant i, dₙ(i) are the undistorted transmitted symbols, A^{RX} is the reception-end IQ distortion matrix and C contains the channel coefficients of the multipath channel.
and furthermore assuming that aₙ^{RX}, a₋ₙ^{RX}≈1, the new distortion parameters (\hat{b}ₙ^{RX}, \hat{b}₋ₙ^{RX}) are generated in accordance with

$${\hat{b}}_{n}^{RX} = \frac{{\hat{d}}_{n}^{′} ( i ) - {C}_{n} \cdot {d}_{n} ( i )}{{C}_{- n}^{*} \cdot {d}_{- n}^{*} ( i )}$$

$${\hat{b}}_{- n}^{RX} = \frac{{\hat{d}}_{- n}^{′} ( i ) - {C}_{- n} \cdot {d}_{- n} ( i )}{{C}_{n}^{*} \cdot {d}_{n}^{*} ( i )} .$$

The method may include the step of: f) with the new IQ distortion parameters determined in method step e), method steps a) to e) are repeated for the received data symbols of a second data block that temporally succeeds the first data block, and g) the received data symbols of the first data block are equalized with the new channel coefficients and new IQ distortion parameters determined in method step f). Alternatively, the method may include the step of: f) with the new IQ distortion parameters determined in method step e), methods steps a) to e) are repeated for the received data symbols of the first data block, and g) the received data symbols of the first data block are equalized with the new channel coefficients and new IQ distortion parameters determined in method step f). The method may be used in a direct-mixing receiver. The method can also be used in a heterodyne receiver with a direct-mixing second stage.

The object can also be achieved by a device for carrying out the method described above, comprising a channel equalizer for equalizing the received data symbols of a data block, an IQ correction circuit for the IQ equalization of the data symbols supplied by the channel equalizer, a symbol decision unit for carrying out a symbol decision process by means of the data symbols supplied by the IQ correction circuit, a channel estimator for generating new channel coefficients on the basis of the reference symbols fed by the symbol decision unit and the received data symbols, and an IQ tracking unit for generating the new IQ distortion parameters on the basis of the new channel coefficients supplied by the channel estimator, the reference symbols and the received data symbols, an output of the IQ tracking unit being connected to an input of the IQ correction circuit.

The device may further comprise an IQ predistortion unit for carrying out an IQ predistortion on the reference symbols supplied by the symbol decision unit on the basis of the updated IQ distortion parameters, wherein the IQ predistortion unit having a first input connected to the output of the symbol decision unit and a second input connected to an output of the IQ tracking unit, and an output connected to the channel estimator. The device may further comprise an averaging unit for carrying out an averaging of the IQ distortion parameters determined on the basis of the new channel coefficients determined during the channel estimation, the reference symbols and the received data symbols with the IQ distortion parameters determined in one or more previous iteration steps, and an input of the averaging unit being connected to an output of the IQ tracking unit and an output of the averaging unit being connected to an input of the IQ correction circuit and an input of the IQ predistortion unit. The device may further comprise a channel estimator, to the input of which the received data symbols can be fed and at the output of which the channel coefficients determined by the channel estimation are supplied. The device may further comprise a changeover switch, by means of which the input of the channel equalizer is connected to the output of the channel estimator or the output of the channel estimator. The device may also comprise an IQ correction circuit for the IQ equalization of the received data symbols, a channel estimator for generating channel coefficients, which is connected to the output of the IQ correction circuit, a channel equalizer for equalizing the received data symbols on the basis of the channel coefficients supplied by the channel estimator, a symbol decision unit for carrying out a symbol decision process by means of the data symbols supplied by the channel equalizer, and an IQ estimator for generating IQ distortion parameters on the basis of the reference symbols supplied by the symbol decision unit and the channel coefficients supplied by the channel estimator, the reference symbols and the received data symbols, an output of the IQ estimator being connected to an input of the IQ correction circuit.

The present invention relates to methods for the estimation and correction of the distortion of radio signals that is caused by transmitter- or receiver-end IQ asymmetries and by channel distortion, which radio signals are transmitted in a multicarrier transmission method in the form of frames or bursts. The method can be employed in all those areas in which multicarrier transmission methods can be used, that is to say e.g. in the area of wireless data transmission networks (WLAN) or in the area of digital terrestrial video or audio signal transmission. One known multicarrier transmission method is for example the OFDM method already described above. The spectrum of the multicarrier transmission method contains subcarriers n and subcarriers −n arranged spectrally symmetrically with respect to the latter with regard to a center frequency f_{c}. The frames in each case contain a number of symbols that are in each case composed of the data symbols dₙ, transmitted on the subcarriers.

As has already been described above, the distortion that is critical for the invention consists in an interference between subcarriers situated mirror-symmetrically on both sides of the center frequency of the multicarrier spectrum. This distortion is critically caused by transmitter- and receiver-end IQ asymmetries. Furthermore, the multipath propagation of the radio channel results in linear distortions of the subcarrier considered. The overall distortion composed of the IQ distortion and the channel distortion can be modeled by the following equation:

$$[ \begin{matrix}{\hat{d}}_{n}^{′} ( i ) \\ {\hat{d}}_{- n}^{′ *} ( i )\end{matrix} ] = \underbrace{[ \begin{matrix}{a}_{n}^{RX} & {b}_{n}^{RX} \\ {b}_{- n}^{RX *} & {a}_{- n}^{RX *}\end{matrix} ]}_{{A}^{RX}} \cdot \underbrace{[ \begin{matrix}{C}_{n} & 0 \\ 0 & {C}_{- n}^{*}\end{matrix} ]}_{C} \cdot \underbrace{[ \begin{matrix}{a}_{n}^{TX} & {b}_{n}^{TX} \\ {b}_{- n}^{TX *} & {a}_{- n}^{TX *}\end{matrix} ]}_{{A}^{TX}} \cdot [ \begin{matrix}{d}_{n} ( i ) \\ {d}_{- n}^{*} ( i )\end{matrix} ] \qquad ( 1 )$$

In this case, \hat{d}′ₙ(i) are the distorted symbols received on the subcarrier n at the instant i, dₙ(i) are the undistorted transmitted symbols, A^{TX} forms the transmitter-end IQ distortion matrix, A^{RX} forms the reception-end IQ distortion matrix, and C contains the channel coefficients of a multipath channel.

The invention is based on the fact that either the transmitter-end or the receiver-end IQ asymmetry is already known. If one of the IQ distortion matrices (A^{RX} or A^{TX}) is already known, therefore, then the coefficients of the respective other IQ distortion matrix and also the channel coefficients C can be iteratively estimated and at the same time the received symbols can be equalized and decided on. In this case, the received multicarrier data symbols (for example OFDM symbols) are processed in blocks. Consequently, in each iteration loop, a data block comprising a group of OFDM symbols is processed and the channel coefficients and IQ distortion parameters determined at the end of the iteration pass are applied to this group of data symbols. This group of data symbols, which is referred to hereinafter as data block, may be a subgroup of the frame or burst. However, depending on the definition of the burst length in the respective standard, it is also conceivable for the data block to correspond to the frame.

This will be illustrated below firstly using the example of the estimation and correction of the transmitter-end IQ error (A^{TX}). The reception-end IQ distortion matrix (A^{RX}) has thus already been estimated and corrected beforehand by means of suitable measures.

With the approximation aₙ^{TX}, a₋ₙ^{TX}≈1 equation (1) becomes

$$[ \begin{matrix}{\hat{d}}_{n}^{′} ( i ) \\ {\hat{d}}_{- n}^{′ *} ( i )\end{matrix} ] = [ \begin{matrix}{C}_{n} & 0 \\ 0 & {C}_{- n}^{*}\end{matrix} ] \cdot [ \begin{matrix}1 & {b}_{n}^{TX} \\ {b}_{- n}^{TX *} & 1\end{matrix} ] \cdot [ \begin{matrix}{d}_{n} ( i ) \\ {d}_{- n}^{*} ( i )\end{matrix} ] \qquad ( 2.1 )$$

With knowledge of the channel coefficients Cₙ, C₋ₙ, the remaining variables of the IQ distortion matrix A^{TX} can be determined by

$${\hat{b}}_{n}^{TX} = \frac{{\hat{d}}_{n}^{′} ( i ) - {C}_{n} \cdot {d}_{n} ( i )}{{C}_{- n} \cdot {d}_{- n}^{*} ( i )} \\ {\hat{b}}_{- n}^{TX} = \frac{{\hat{d}}_{- n}^{′} ( i ) - {C}_{- n} \cdot {d}_{- n} ( i )}{{C}_{n} \cdot {d}_{n}^{*} ( i )} \qquad ( 2.2 )$$

A first method according to the invention for the estimation and correction of the transmitter-end IQ asymmetry can be carried out on this basis. In the case of the first method according to the invention in its most general form, firstly in a method step a), the received data symbols of a first data block are equalized with the channel coefficients determined from the preceding data block. In a method step b), the data symbols are subsequently equalized with the IQ distortion parameters determined from a temporally preceding data block. The data symbols that have been equalized in this way are subsequently subjected to a symbol decision process in a method step c). In a method step d), the reference symbols supplied by the symbol decision process and the received data symbols are provided for a channel estimation for generating new channel coefficients. Finally, in a method step e), the new IQ distortion parameters are estimated on the basis of the new channel coefficients determined during the channel estimation, the reference symbols and the received data symbols.

The data block of received data symbols, which is designated as first data block, is by definition an arbitrary data block of the radio signal transmission. The designation first data block serves merely for linguistic identification and differentiation from the second data block that temporally succeeds it.

The radio transmission data block which is actually the first data block with respect to time is designated here as initialization data block. In the case of this initialization data block, the method according to the invention cannot initially be performed in the same way as in the case of all the subsequent data blocks since a temporally preceding data block does not yet exist. The received data symbols contained in the initialization data block can be equalized in method steps a) and b) in such a way that a channel estimation is carried out on the basis of pilot signals, as are usually contained in a preamble of the corresponding data burst to which the initialization data block belongs. In method step a), the received data symbols are equalized with the channel coefficients determined from the channel estimation and, in method step b), the IQ distortion parameters are set to be equal to zero.

After new channel coefficients and new IQ distortion parameters have been determined in method steps d) and e) in the method according to the invention, a further iteration step can be carried out, in which, with the new channel coefficients and the new IQ distortion parameters, method steps a) to e) are repeated for the received data symbols of a second data block that temporally succeeds the first data block (method step f.), and the received data symbols of the first data block are equalized with the new channel coefficients and new IQ distortion parameters determined in method step f. (method step g.).

As an alternative to this, it may also be provided that, in method step f), with the new channel coefficients and new IQ distortion parameters determined in method steps d) and e), method steps a) to e) are repeated for the received data symbols of the first data block. It is thus optionally possible to carry out this iteration step and further iteration steps for updating the channel coefficients and the IQ distortion parameters on the basis of the first data block or the data blocks that temporally succeed it.

The iteration described further above with method steps f) and g) for updating the channel coefficients and IQ distortion parameters may, if appropriate, be followed by further iteration steps which in each case run through method steps a) to e). After the end of the last iteration step provided, the received data symbols are equalized with the channel coefficients and IQ distortion parameters that have been updated for the last time, and subjected to the symbol decision process and the data symbols decided on are output to a next processing unit of the receiver.

It may be provided that in method step d), the new channel coefficients are generated by virtue of the fact that the channel coefficients determined from a channel estimation on the basis of the reference symbols supplied by the symbol decision process and the received data symbols are subjected to a weighted averaging with the old values of the channel coefficients, so that the IQ error according to equation (2.2) can be estimated anew on the basis of these averaged channel coefficients, the reference symbols and the received data symbols in method step e. (IQ tracking).

It may furthermore be provided that in method step e), the new IQ distortion parameters are generated by virtue of the fact that the IQ distortion parameters determined on the basis of the new channel coefficients determined during the channel estimation, the reference symbols and the received data symbols are averaged with the IQ distortion parameters determined in one or more previous iteration steps.

It is furthermore advantageous if prior to carrying out the channel estimation in method step d), an IQ predistortion of the reference symbols supplied by the symbol decision process is carried out on the basis of the updated IQ distortion parameters. This EQ predistortion of the reference symbols makes it possible to considerably reduce the estimation error as a result of the IQ distortion.

A second method according to the invention serves for the estimation and correction of the receiver-end IQ asymmetry. Once again proceeding from equation (1), it is assumed in this case that the transmitter-end IQ distortion matrix (A^{TX}) has already been estimated and corrected beforehand by means of suitable measures. With the approximation aₙ^{TX}, a₋ₙ^{TX}≈1 and given knowledge of the channel coefficients Cₙ, C₋ₙ, the remaining variables of the IQ distortion matrix A^{RX} can be determined by

$${\hat{b}}_{n}^{RX} = \frac{{\hat{d}}_{n}^{′} ( i ) - {C}_{n} \cdot {d}_{n} ( i )}{{C}_{- n}^{*} \cdot {\hat{d}}_{- n}^{*} ( i )} \\ {\hat{b}}_{- n}^{RX} = \frac{{\hat{d}}_{- n}^{′} ( i ) - {C}_{- n} \cdot {d}_{- n} ( i )}{{C}_{n}^{*} \cdot {\hat{d}}_{n}^{*} ( i )} \qquad ( 3.1 )$$

A second method according to the invention for the estimation and correction of the receiver-end IQ asymmetry can be carried out on this basis. In the case of this second method according to the invention in its most general form, firstly, in a method step a) the received data symbols of a first data block are equalized with the IQ distortion parameters determined from a temporally preceding data block. The data symbols are subsequently provided for a channel estimation for generating new channel coefficients in a method step b) and are subsequently equalized, in a method step c), with the channel coefficients determined. The data symbols that have been equalized in this way are subsequently subjected to a symbol decision process in a method step d). Afterward, in a method step e) an IQ estimation is carried out on the basis of the reference symbols supplied by the symbol decision process and the channel coefficients supplied by the channel estimation and the IQ distortion parameters determined are supplied to the IQ correction circuit.

### BRIEF DESCRIPTION OF THE DRAWINGS

Exemplary embodiments for carrying out the methods according to the invention and corresponding devices for carrying out the methods according to the invention are illustrated in greater detail below in conjunction with the figures of the drawing, in which:

FIG. 1 shows the frequency spectrum of the OFDM transmission method;

FIG. 2 shows a receiver-end block circuit arrangement for carrying out a method according to the invention for the estimation and correction of transmitter-end IQ asymmetries;

FIG. 3 shows a receiver-end block circuit arrangement for carrying out a method according to the invention for the estimation and correction of receiver-end IQ asymmetries.

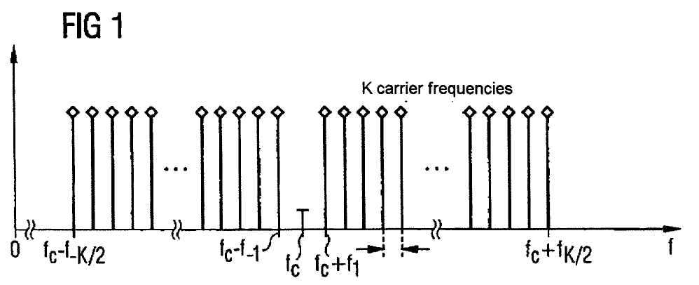

### DETAILED DESCRIPTION OF THE PREFERRED EMBODIMENTS

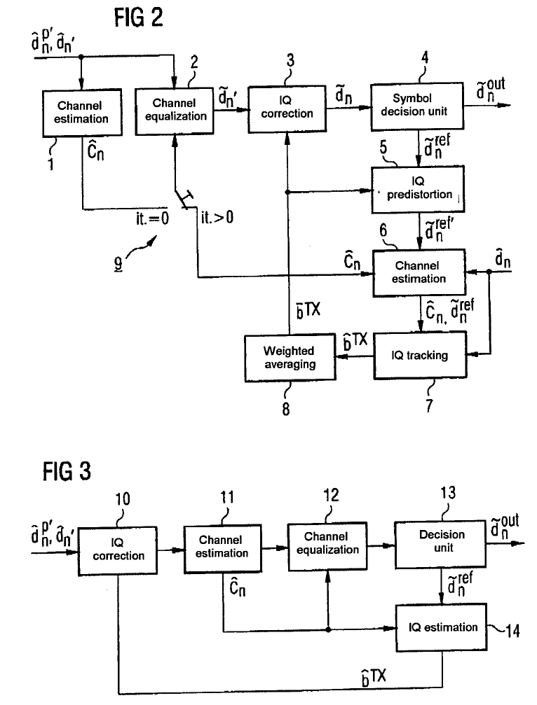

The exemplary embodiment shown in FIG. 2 and the variables used therein relate to the case of estimation and correction of a transmitter-end IQ asymmetry, both the channel coefficients Cₙ, C₋ₙ and the transmitted symbols dₙ(i) and d₋ₙ(i) being required for determining the IQ distortion parameters \hat{b}ₙ^{TX} and \hat{b}ₙ^{TX} (cf. equation (2.2)).

The device that is contained in a receiver and illustrated in FIG. 2 is fed received data symbols \hat{d}ₙ^{p′}, \hat{d}′ₙ, the data symbols being contained in data blocks. A plurality of data blocks form a frame, each frame having preamble symbols \hat{d}ₙ^{p′}. The data symbols, which are formed by OFDM symbols in the exemplary embodiment, are fed to a channel equalizer 2, in which they are equalized with the channel coefficients ĉₙ determined from the preceding data block.

The equalized data symbols are subsequently fed to an IQ error correction circuit 3, in which an IQ error correction is carried out with the IQ distortion parameters \overline{b}ₙ^{TX}, \overline{b}₋ₙ^{TX} determined from the preceding data block.

The equalized and IQ-corrected data symbols are then fed to a symbol decision unit 4 having two outputs. After the symbol decision, new reference symbols are available for all the subcarriers n/−n and are output to a first output of the symbol decision unit 4.

A new channel estimation can be carried out on the basis of these reference symbols in a channel estimator 6, to which the received data symbols \hat{d}′ₙ are likewise fed. The reference symbols supplied by the symbol decision unit 4 are fed to an IQ predistorter 5 beforehand, to which the updated IQ distortion parameters \overline{b}^{TX} are likewise fed. The IQ predistortion reduces the estimation error as a result of the IQ distortion.

The channel coefficients calculated in the channel estimator 6 are subjected to a weighted averaging with the old values, so that, on the basis of these averaged channel coefficients, the reference symbols and the reception values, the IQ error can be estimated anew in an IQ tracking unit 7, to which the reception symbols \hat{d}′ₙ are likewise fed. After the estimation of \hat{b}ₙ^{TX} and \hat{b}₋ₙ^{TX} for each subcarrier pair that is available, it is possible to carry out an averaging of the values in the time direction (by means of an iteration block) for the purpose of noise reduction. These estimated values are then averaged with those from the previous iteration in an averaging unit 8 (weighted averaging).

A next iteration can then be carried out with the updated values of the channel coefficients and of the IQ distortion parameters that are fed to the channel equalizer 2 and the IQ correction circuit 3. Said iteration can be carried out using the data block of received OFDM symbols that temporally succeeds the current data block. However, it is equally possible to carry out an improvement of the estimated values by multiple iteration on the basis of the same reception data block.

In order to initialize the parameters, before the first iteration (it=0), an OFDM channel estimation is effected on the basis of reference data such as, for example, the symbols \hat{d}ₙ^{p}′ transmitted in a preamble, as are indicated in FIG. 2, bₙ^{TX}, b₋ₙ^{X}=0 is assumed as initial value for the IQ distortion parameters of the IQ correction circuit 3, so that the IQ correction (as well as the IQ predistortion) remains ineffective in the first iteration. However, it is equally possible also to improve the transient response of the control by means of a suitable initial estimation of the IQ distortion parameters.

The exemplary embodiment shown in FIG. 3 and the variables used therein relate to the case of estimation and correction of a receiver-end IQ asymmetry, the \hat{b}ₙ^{RX} and \hat{b}₋ₙ^{RX} equation (3.1) serving as a basis for determining the IQ distortion parameters.

The device that is contained in a receiver and illustrated in FIG. 3 is fed received data symbols \hat{d}ₙ^{p′}, \hat{d}′ₙ. The data symbols are firstly fed to an IQ correction circuit 10, in which an IQ correction is carried out on the basis of IQ distortion parameters as had been determined on the basis of a previous iteration pass on the basis of an earlier group of data symbols.

The IQ-corrected data symbols are then fed to a channel estimator 11 for determining channel coefficients and subsequently equalized in a channel equalizer 12 on the basis of the channel coefficients determined by the channel estimator 11.

The channel-equalized reception symbols are then fed to a symbol decision unit 13, in which a symbol decision process is carried out on the equalized data symbols. The symbol decision unit 13 has two outputs. After the symbol decision, new reference symbols are available for all the subcarriers n/−n, which reference symbols are output to a first output of the symbol decision unit 13.

The reference symbols are supplied to an IQ estimator 14, in which an estimation of the IQ distortion parameters is carried out on the basis of the reference symbols and the channel coefficients supplied by the channel estimator 11. The IQ distortion parameters newly estimated by the IQ estimator 14 are supplied to the IQ correction circuit 10, so that a renewed iteration can be run through on the basis of the current data block or a next data block.

The present invention can generally be applied to those receiver concepts in which a branching of the received input signal between an I and Q branch is performed whilst still in the analog circuit part of the receiver. The most important application of the invention thus relates to a so-called direct-mixing receiver known per se, as is shown for example in FIG. 3.5 of the dissertation by Schuchert cited in the introduction. However, the invention can equally be applied, in principle, to a heterodyne receiver with a direct-mixing second stage that is equally known per se, as is shown for example in FIG. 3.6 of the aforementioned dissertation and is described in the associated text. Such a heterodyne receiver with a direct-mixing second stage is a modification of a heterodyne receiver in which the second mixing stage is embodied as a direct-mixing analog quadrature receiver. The IQ errors described in the introduction can occur in such a receiver, too, and can be estimated and equalized by means of the method according to the invention.

1. A method for the estimation and correction of the distortion of radio signals that is caused by transmitter-end IQ asymmetries and by channel distortion, given known receiver-end IQ asymmetry, comprising the steps of:
transmitting radio signals in a multicarrier transmission method with subcarriers n and subcarriers −n arranged spectrally symmetrically with respect to the latter with regard to a center frequency f_{c},
wherein
a) the received data symbols of a first data block are firstly equalized with the channel coefficients determined from the preceding data block,
b) the data symbols are subsequently equalized with the IQ distortion parameters determined from a temporally preceding data block,
c) the equalized data symbols are subsequently subjected to a symbol decision process, and
d) reference symbols supplied from the symbol decision process and the received data symbols are provided for a channel estimation for generating new channel coefficients, and
e) assuming that
$$[ \begin{matrix}{\hat{d}}_{n}^{′} ( i ) \\ {\hat{d}}_{- n}^{′ *} ( i )\end{matrix} ] = \underbrace{[ \begin{matrix}{C}_{n} & 0 \\ 0 & {C}_{- n}^{*}\end{matrix} ]}_{C} \cdot \underbrace{[ \begin{matrix}{a}_{n}^{TX} & {b}_{n}^{TX} \\ {b}_{- n}^{TX *} & {a}_{- n}^{TX *}\end{matrix} ]}_{{A}^{TX}} \cdot [ \begin{matrix}{d}_{n} ( i ) \\ {d}_{- n}^{*} ( i )\end{matrix} ]$$
where \hat{d}′ₙ(i) are the distorted symbols received on the subcarrier n at the instant i, dₙ(i) are the undistorted transmitted symbols, A^{TX} forms the transmitter-end IQ distortion matrix,
and C contains the channel coefficients of the multipath channel,
and furthermore assuming that aₙ^{TX}, a₋ₙ^{TX}≈1, the new distortion parameters bₙ^{TX}, b₋ₙ^{TX} , are generated in accordance with
$${\hat{b}}_{n}^{TX} = \frac{{\hat{d}}_{n}^{′} ( i ) - {C}_{n} \cdot {d}_{n} ( i )}{{C}_{n} \cdot {d}_{- n}^{*} ( i )}$$
$${\hat{b}}_{- n}^{TX} = \frac{{\hat{d}}_{- n}^{′} ( i ) - {C}_{- n} \cdot {d}_{- n} ( i )}{{C}_{- n} \cdot {d}_{n}^{*} ( i )}$$

2. The method as claimed in claim 1,
wherein
at the beginning of the method, the data symbols contained in an initialization data block are equalized in method steps a) and b) in such a way that
a channel estimation is carried out on the basis of pilot signals, and the received data symbols are equalized in method step a) with the channel coefficients determined from the channel estimation, and
the IQ distortion parameters are set to be equal to zero in method step b).

3. The method as claimed in claim 1,
wherein
f) with the new channel coefficients and new IQ distortion parameters determined in method steps d) and e), method steps a) to e) are repeated for the received data symbols of a second data block that temporally succeeds the first data block, and
g) the received data symbols of the first data block are equalized with the new channel coefficients and new IQ distortion parameters determined in method step f).

4. The method as claimed in claim 1,
wherein
f) with the new channel coefficients and new IQ distortion parameters determined in method steps d) and e), methods steps a) to e) are repeated for the first data block, and
g) the received data symbols of the first data block are equalized with the new channel coefficients and new IQ distortion parameters determined in method step f).

5. The method as claimed in claim 1,
wherein
in method step d), the new channel coefficients are generated by virtue of the fact that the channel coefficients determined from a channel estimation on the basis of the reference symbols supplied by the symbol decision process and the received data symbols are subjected to a weighted averaging with the old values of the channel coefficients.

6. The method as claimed in claim 1,
wherein
in method step e), the new IQ distortion parameters are generated by virtue of the fact that the IQ distortion parameters determined on the basis of the new channel coefficients determined during the channel estimation, the reference symbols and the received data symbols are averaged with the IQ distortion parameters determined in one or more previous iteration steps.

7. The method as claimed in claim 1,
wherein
prior to method step d), an IQ predistortion of the reference symbols supplied by the symbol decision process is carried out on the basis of the updated IQ distortion parameters.

8. A method for the estimation and correction of the distortion of radio signals that is caused by receiver-end IQ asymmetries and by channel distortion, given known transmitter-end IQ asymmetry, comprising the steps of:
transmitting radio signals in a multicarrier transmission method with subcarriers n and subcarriers −n arranged spectrally symmetrically with respect to the latter with regard to a center frequency fc
wherein
a) the received data symbols of a first data block are equalized with the IQ distortion parameters determined from a temporally preceding data block,
b) the IQ-equalized data symbols are subsequently fed to a channel estimation for determining channel coefficients,
c) the data symbols are subsequently equalized with the channel coefficients, and
d) the channel-equalized data symbols are subjected to a symbol decision process, and
e) assuming that
$$[ \begin{matrix}{\hat{d}}_{n}^{′} ( i ) \\ {\hat{d}}_{- n}^{′ *} ( i )\end{matrix} ] = \cdot [ \begin{matrix}{a}_{n}^{RX} & {b}_{n}^{RX} \\ {b}_{- n}^{RX *} & {a}_{- n}^{RX *}\end{matrix} ] \cdot [ \begin{matrix}{C}_{n} & 0 \\ 0 & {C}_{- n}^{*}\end{matrix} ] \cdot [ \begin{matrix}{d}_{n} ( i ) \\ {d}_{- n}^{*} ( i )\end{matrix} ] ,$$
where \hat{d}40 ₙ(i) are the distorted symbols received on the subcarrier n at the instant i, dₙ(i) are the undistorted transmitted symbols, A^{RX} is the reception-end IQ distortion matrix and C contains the channel coefficients of the multipath channel.
and furthermore assuming that aₙ^{RX}, a₋ₙ^{RX}≈1, the new distortion parameters (\hat{b}ₙ^{RX}, \hat{b}₋ₙ^{RX}) are generated in accordance with
$${\hat{b}}_{n}^{RX} = \frac{{\hat{d}}_{n}^{′} ( i ) - {C}_{n} \cdot {d}_{n} ( i )}{{C}_{- n}^{*} \cdot {\hat{d}}_{- n}^{*} ( i )}$$
$${\hat{b}}_{- n}^{RX} = \frac{{\hat{d}}_{- n}^{′} ( i ) - {C}_{- n} \cdot {d}_{- n} ( i )}{{C}_{n}^{*} \cdot {d}_{n}^{*} ( i )}$$

9. The method as claimed in claim 8,
wherein
f) with the new IQ distortion parameters determined in method step e), method steps a) to e) are repeated for the received data symbols of a second data block that temporally succeeds the first data block, and
g) the received data symbols of the first data block are equalized with the new channel coefficients and new IQ distortion parameters determined in method step f).

10. The method as claimed in claim 8,
wherein
f) with the new IQ distortion parameters determined in method step e), methods steps a) to e) are repeated for the received data symbols of the first data block, and
g) the received data symbols of the first data block are equalized with the new channel coefficients and new IQ distortion parameters determined in method step f).

11. A method comprising the step of using of a method as claimed in claim 1 in a direct-mixing receiver.

12. A method comprising the step of using of a method as claimed in claim 1 in a heterodyne receiver with a direct-mixing second stage.

13. A device for carrying out the method as claimed in claim 1, comprising
a channel equalizer for equalizing the received data symbols of a data block,
an IQ correction circuit for the IQ equalization of the data symbols supplied by the channel equalizer,
a symbol decision unit for carrying out a symbol decision process by means of the data symbols supplied by the IQ correction circuit,
a channel estimator for generating new channel coefficients on the basis of the reference symbols fed by the symbol decision unit and the received data symbols,
an IQ tracking unit for generating the new IQ distortion parameters on the basis of the new channel coefficients supplied by the channel estimator, the reference symbols and the received data symbols, an output of the IQ tracking unit being connected to an input of the IQ correction circuit.

14. The device as claimed in claim 13,
comprising
an IQ predistortion unit for carrying out an IQ predistortion on the reference symbols supplied by the symbol decision unit on the basis of the updated IQ distortion parameters,
the IQ predistortion unit having a first input connected to the output of the symbol decision unit and a second input connected to an output of the IQ tracking unit, and an output connected to the channel estimator.

15. The device as claimed in claim 13,
comprising
an averaging unit for carrying out an averaging of the IQ distortion parameters determined on the basis of the new channel coefficients determined during the channel estimation, the reference symbols and the received data symbols with the IQ distortion parameters determined in one or more previous iteration steps, and
an input of the averaging unit being connected to an output of the IQ tracking unit and an output of the averaging unit being connected
to an input of the IQ correction circuit and an input of the IQ predistortion unit.

16. The device as claimed in claim 13,
comprising
a channel estimator, to the input of which the received data symbols can be fed and at the output of which the channel coefficients determined by the channel estimation are supplied.

17. The device as claimed in claim 16,
comprising
a changeover switch, by means of which the input of the channel equalizer is connected to the output of the channel estimator or the output of the channel estimator.

18. A device for carrying out the method as claimed in claim 8, comprising
an IQ correction circuit for the IQ equalization of the received data symbols,
a channel estimator for generating channel coefficients, which is connected to the output of the IQ correction circuit,
a channel equalizer for equalizing the received data symbols on the basis of the channel coefficients supplied by the channel estimator,
a symbol decision unit for carrying out a symbol decision process by means of the data symbols supplied by the channel equalizer, and
an IQ estimator for generating IQ distortion parameters on the basis of the reference symbols supplied by the symbol decision unit and the channel coefficients supplied by the channel estimator, the reference symbols and the received data symbols, an output of the IQ estimator being connected to an input of the IQ correction circuit.

19. A device for the estimation and correction of the distortion of radio signals that is caused by transmitter-end IQ asymmetries and by channel distortion, given known receiver-end IQ asymmetry, comprising:
means for transmitting radio signals in a multicarrier transmission method with subcarriers n and subcarriers −n arranged spectrally symmetrically with respect to the latter with regard to a center frequency f_{c},
means for firstly equalizing the received data symbols of a first data block with the channel coefficients determined from the preceding data block,
means for subsequently equalizing the data symbols with the IQ distortion parameters determined from a temporally preceding data block,
means for subsequently subjecting the equalized data symbols to a symbol decision process, and
means for supplying reference symbols from the symbol decision process and providing the received data symbols for a channel estimation for generating new channel coefficients,
wherein the device assumes that
$$[ \begin{matrix}{\hat{d}}_{n}^{′} ( i ) \\ {\hat{d}}_{- n}^{′ *} ( i )\end{matrix} ] = \underbrace{[ \begin{matrix}{C}_{n} & 0 \\ 0 & {C}_{- n}^{*}\end{matrix} ]}_{C} \cdot \underbrace{[ \begin{matrix}{a}_{n}^{TX} & {b}_{n}^{TX} \\ {b}_{- n}^{TX *} & {a}_{- n}^{TX *} 1\end{matrix} ]}_{{A}^{TX}} \cdot [ \begin{matrix}{d}_{n} ( i ) \\ {d}_{- n}^{*} ( i )\end{matrix} ] ,$$
wherein \hat{d}′ₙ(i) are the distorted symbols received on the subcarrier n at the instant i, dₙ(i) are the undistorted transmitted symbols, A^{TX} forms the transmitter-end IQ distortion matrix,
and C contains the channel coefficients of the multipath channel,
and furthermore the device assumes that aₙ^{TX}, a₋ₙ^{TX}≈1, the new distortion parameters \hat{b}ₙ^{TX}, \hat{b}ₙ^{TX} are generated in accordance with
$${\hat{b}}_{n}^{TX} = \frac{{\hat{d}}_{n}^{′} ( i ) - {C}_{n} \cdot {d}_{n} ( i )}{{C}_{n} \cdot {d}_{- n}^{*} ( i )}$$
$${\hat{b}}_{- n}^{TX} = \frac{{\hat{d}}_{- n}^{′} ( i ) - {C}_{- n} \cdot {d}_{- n} ( i )}{{C}_{- n} \cdot {d}_{n}^{*} ( i )}$$
